(19) United States
(12) Patent Application Publication
(10) Pub. No.: US 2021/0309418 A1
(43) Pub. Date: Oct. 7, 2021

(54) BAG SUPPORT STRUCTURE

(71) Applicant: William DeBlois, Rome, NY (US)

(72) Inventor: William DeBlois, Rome, NY (US)

(21) Appl. No.: 16/839,698

(22) Filed: Apr. 3, 2020

(51) Int. Cl. B65D 33/02

(52) U.S. Cl. CPC B65D 33/02; B65D 2275/00

(57) ABSTRACT

A bag support has an inner surface and outer surface. The bag support includes a first generally planar side opposite a second generally planar side; a first foldable side opposite a second foldable side. The bag support is movable between an operation state and a storage state, the first and second foldable sides unfold to define the operation state and fold to define the storage state, and in the operation state, the inner surface, when bounded by a flat bottom and a flat top of which there is none, defines a volume within which a bag may be placed to receive objects, wherein the bag extends from the volume to engage the outer surface.

### BACKGROUND

When cutting vegetables and fruit in the kitchen, a person often generates food waste in rinds, stems, seeds, and other portions most people don't eat. The person doing the preparation has to pick up the food waste and move it to their garbage or compost bin, which usually involves walking across a room to the location of the waste container. This can result in increased mess while the food waste leaks onto the floor or preparer, and also results in lost time moving around the kitchen.

### SUMMARY OF THE EMBODIMENTS

A bag support 100 has an inner surface 112 and outer surface 114. The bag support 100 includes a first generally planar side 120 opposite a second generally planar side 122; a first foldable side 130 opposite a second foldable side 140. The bag support 100 is movable between an operation state 102 and a storage state 104, the first and second foldable sides 130, 140 unfold to define the operation state and fold to define the storage state, and in the operation state, the inner surface 112, when bounded by a flat bottom and a flat top of which there is none, defines a volume 140 within which a bag 300 may be placed to receive objects, wherein the bag extends from the volume 140 to engage the outer surface 114.

### BRIEF DESCRIPTION OF THE DRAWINGS

FIG. 1A shows an isometric top view of the bag support in its mostly expanded operational state.

FIG. 1B shows an enlarged cross section through the line 1B-1B in FIG. 1A.

FIG. 2 shows a top view of the bag support in its mostly compressed storage state.

FIG. 3 shows an isometric top view of the bag support of FIG. 1A, in use with a bag therein.

FIG. 4 shows an isometric top view of the bag support in its fully expanded operational state with suggested dimensions.

FIG. 5A shows an isometric top view of another embodiment of the bag support in its operational state.

FIGS. 5B and 5D show cross sections through the lines 5B-5B and 5D-5D respectively in FIG. 5A.

FIG. 5C shows a view of the bag support of FIG. 5A in its storage state.

### DETAILED DESCRIPTION OF THE EMBODIMENTS

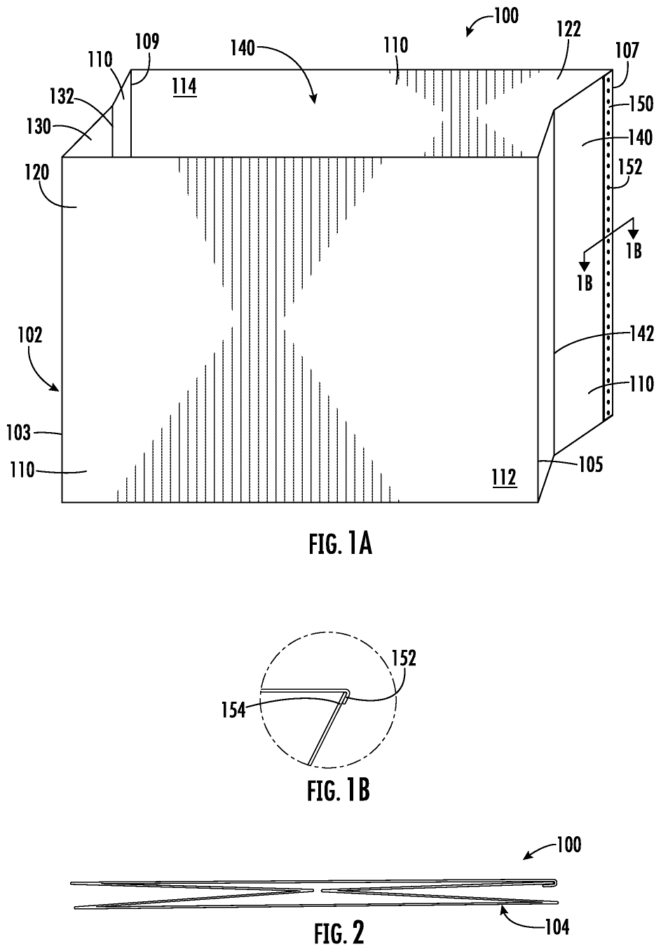

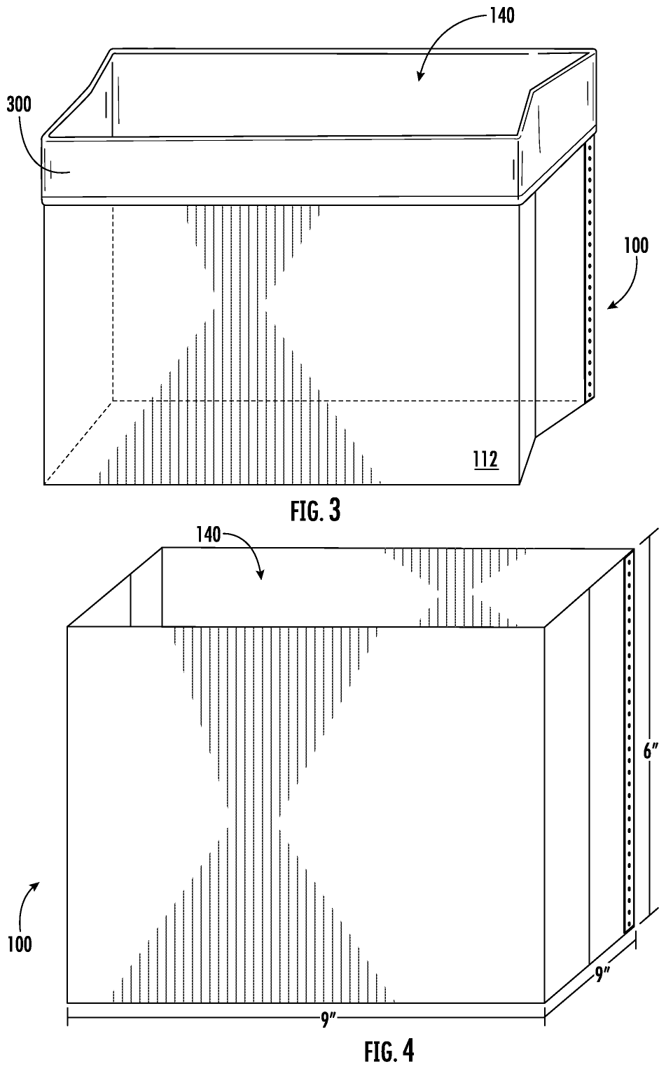

FIGS. 1A, 1B, 2, 3, and 4 show a bag support 100 with an inner surface 112 and outer surface 114. The bag support 100 includes a first generally planar side 120 opposite a second generally planar side 122 and a first foldable side 130 opposite a second foldable side 140. The bag support 100 is movable between an operation state 102 (FIGS. 1A, 3, and 4) and a storage state 104 (FIG. 2) and the first and second foldable sides 130, 140 unfold to define the operation 102 state and fold to define the storage state 104. In the operation state 102, the bag support need not have its foldable sides fully extended, as long as the support can support itself and a bag 300. In the folded state 104, the bag support is generally flat for easy storage.

In the operation state, the inner surface 112, when bounded by a flat bottom and a flat top of which there is none, i.e., the support is open at the top and bottom, defines a volume 140 within which a bag 300 (FIG. 3) may be placed to receive objects, wherein the bag extends from the volume 140 to engage the outer surface 114. The objects received may be kitchen food scraps or other waste and the bag may be a common grocery plastic bag, or other preferably recycled material bag that may be easily composted.

The bag support 100 may define a single wall 110 the further defines the first and second generally planar sides 112, 114 and the first and second foldable sides 120, 130. The foldable sides may contain scoring 132, 142 to allow for easy and defined folding, where the scoring is through the midline of each side. The corners 103, 105, 107, 109 of the bag support 100 may also be scored for easy folding.

The single wall 110 may be a uniform material made from polypropylene or other suitable material.

The bag support may include an overlap portion 150 in which an overlap edge 152 overlaps a side engagement edge 154, where the side engagement edge 154 is a portion of one of the first planar side 112, second planar side 114, first foldable side 130, or second foldable side 140.

The overlap edge 152 and side engagement edge 154 may be engaged to each other through heat sealing, an adhesive, or through a friction engagement.

The volume may be 364 cubic inches in the operation state with fully extended side dimensions of 9 inches length by 6 inches height by 9 inches deep.

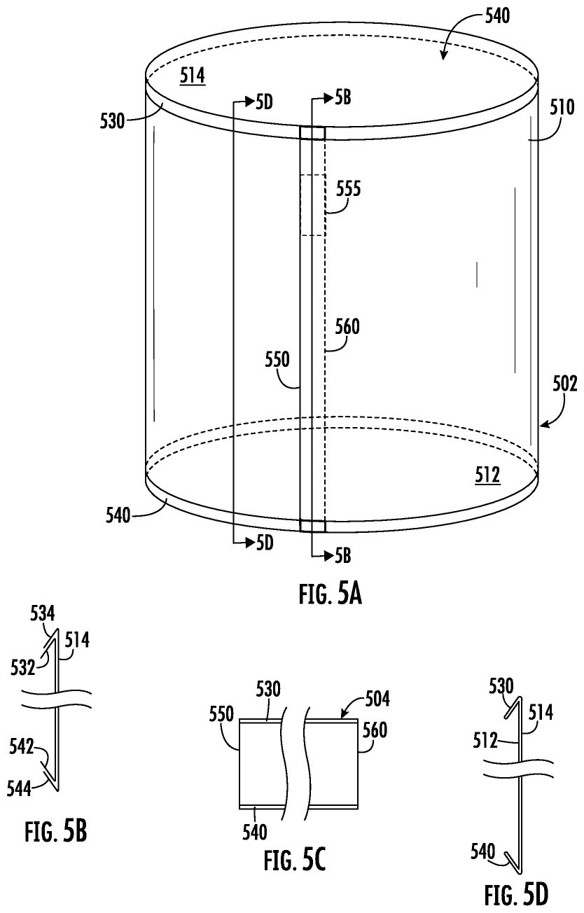

As shown in FIGS. 5A-5D, the bag support 500 may include an inner surface 514 and outer surface 512 made from a single sheet 510 that is movable between an operation state 502 and a storage state 504. The operational state 502 defines a substantially cylindrical volume 540 when bounded by a flat top and bottom of which there is none, i.e. the support 500 defines an open cylinder shape.

The support 500 includes a top edge 530 and a bottom edge 540 where the edges are folded towards outer surface 512 and in the operation state, the cylindrical volume 540 may be configured to receive a bag 300 that receives objects, where the bag extends from the cylindrical volume 540 to engage the outer surface 514.

The bag support single sheet defines a leading edge 550 and following edge 560, where in the operation state, the leading edge 550 and the following edge 560 create an overlap 555 such that the leading edge extends over the following edge 560 except that a leading edge top edge portion 532 is tucked within a following edge top edge portion 542 and a leading edge bottom edge portion 534 is tucked within a following edge bottom edge portion 544, wherein the engagement of the leading and following edges 550, 560 and the edge portions 532, 542, 534, 544 maintain the operational state.

The top and bottom edges 530, 540 are defined by a scored fold along the top of the support such that the top and bottom edges are retained in the operation shape. The engagement of the leading and following edges 550, 560 and the edge portions 532, 542, 534, 544 are maintained through a friction engagement.

The bag supports could be used for food scraps, filling sandbags, or other manner of bag filling for which it would be helpful to have a stored relatively flat state and an operating state in which the bag volume could be easily accessed.

While the invention has been described with reference to the embodiments above, a person of ordinary skill in the art would understand that various changes or modifications may be made thereto without departing from the scope of the claims.

1. A bag support with an inner surface and outer surface, the bag support comprising:
a first generally planar side opposite a second generally planar side;
a first foldable side opposite a second foldable side;
wherein the bag support is movable between an operation state and a storage state;
wherein the first and second foldable sides unfold to define the operation state and fold to define the storage state;
wherein in the operation state, the inner surface, when bounded by a flat bottom and a flat top of which there is none, defines a volume within which a bag may be placed to receive objects, wherein the bag extends from the volume to engage the outer surface.

2. The bag support of claim 1, wherein a single wall defines the first and second generally planar sides and the first and second foldable sides.

3. The bag support of claim 2, wherein the single wall is a uniform material.

4. The bag support of claim 3, wherein the bag support contains an overlap portion in which an overlap edge overlaps a side engagement edge, wherein the side engagement edge is a portion of one of the first planar side, second planar side, first foldable side, or second foldable side.

5. The bag support of claim 4, wherein the overlap edge and side engagement edge are engaged to each other through heat sealing.

6. The bag support of claim 4, wherein the overlap edge and side engagement edge are engaged to each other through an adhesive.

7. The bag support of claim 4, wherein the overlap edge and side engagement edge are engaged to each other through a friction engagement.

8. The bag support of claim 1, wherein the volume is 364 cubic inches in the operation state.

9. The bag support of claim 1, wherein dimensions defined by the volume in the operation state are 9 inches wide by 9 inches deep by 6 inches high.

10. A bag support with an inner surface and outer surface, the bag support comprising:
a single sheet that is movable between an operation state and a storage state, wherein the operational state defines a substantially cylindrical volume when bounded by a flat top and bottom of which there is none;
a top edge and a bottom edge; wherein the edges are folded towards outer surface;
wherein in the operation state, the cylindrical volume is configured to receive a bag that receives objects, wherein the bag extends from the cylindrical volume to engage the outer surface.

11. The bag support of claim 10, the single sheet defines a leading edge and following edge.

12. The bag support of claim 10, wherein in the operation state, the leading edge and the following edge create an overlap such that the leading edge extends over the following edge except that a leading edge top edge portion is tucked within a following edge top edge portion and a leading edge bottom edge portion is tucked within a following edge bottom edge portion, wherein the engagement of the leading and following edges and the edge portions maintain the operational state.

13. The bag support of claim 10, wherein the engagement of the leading and following edges and the edge portions is maintained through a friction engagement.
